(19) United States
(12) Patent Application Publication
(10) Pub. No.: US 2020/0106727 A1
(43) Pub. Date: Apr. 2, 2020

(54) INFORMATION SERVICE SYSTEM AND METHOD THEREOF

(71) Applicant: SONNY INDUSTRIAL CO., LTD., Taipei City (TW)

(72) Inventor: Yu-Luan Hsu, Taipei City (TW)

(21) Appl. No.: 16/144,387

(22) Filed: Sep. 27, 2018

(51) Int. Cl. H04L 12/58; G06F 3/0481; G06K 7/14; H04L 29/06; G06K 7/10

(52) U.S. Cl. CPC H04L 51/10; G06F 3/04815; H04L 51/046; G06T 19/006; H04L 63/083; G06K 7/10722; G06K 7/10831; G06K 7/1417

(57) ABSTRACT

Disclosed is an information service system and method thereof applied to an Augmented Reality information service environment. The method includes: performing a login step, scanning QR Code with a lens of an electronic device and/or logging in a PIN number on a website to start a user interface; performing an Augmented Reality initiation step, after scanning a pattern and/or logging into the website, an Augmented Reality vision with a 3D animation appears, after a user clicks on the 3D animation, a multimedia file appears on the Augmented Reality vision with the 3D animation; and performing an information processing/transmission step, in the multimedia file, text information and/or pictures and/or personal photos and/or video recordings may be added in addition to an original image/text content, the processing of a background for the multimedia file can be performed and/or the instant video recording interacting with the multimedia file can be performed, and the processed multimedia file can be transmitted via an instant messaging software.

### BACKGROUND OF THE INVENTION

### 1. Field of the Invention

The present invention relates to an information service system and method thereof, and more particularly to an information service system and method thereof applied to an Augmented Reality information service environment. In the information service system and method, a multimedia file (such as cards, creative works or image creations) appears in an Augmented Reality vision with a 3D animation, and information of the multimedia file (such as cards, creative works or image creations) can be processed. In addition to the original image/text content, text information and/or pictures and/or personal photos and/or video recordings can be added thereto, and the processing of a background for the multimedia files (such as cards, creative works or image creations) can be performed, and/or an instant video recording interacting with the multimedia file can be performed, the processed multimedia file (such as cards, creative works or image creations) can be transmitted via an instant messaging software.

### 2. The Prior Arts

In the current Augmented Realities, common applications are that after a user opens an Augmented Reality application App and uses a camera of a mobile phone to align or scan actual sightseeing spots or street scenes, in addition to displaying the actual sightseeing spots or street scenes on the mobile screen, some texts and/or pictures and/or multimedia files can be added to the actual sightseeing spots or street scenes on the screen. However, this is also a general application of the Augmented Realities.

However, in general, when users use the Augmented Reality application App, it is not possible to perform other operations on the Augmented Reality vision with texts and/or pictures and/or multimedia files. In other words, the function that the users can use/obtain is only the function of browsing. The users only can browse the added texts and/or pictures and/or multimedia files on the Augmented Reality vision, that is, it is not possible to perform some operations on the Augmented Reality vision with texts and/or pictures and/or multimedia files, such as adding text information and/or pictures, processing the background of the multimedia files (such as cards, creative works or image creations), taking an instant video recording interacting with the multimedia files (such as cards, creative works or image creations), and/or transmitting the processed multimedia files (such as cards, creative works or image creations) via an instant messaging software.

Taiwanese Patent No. I633464, “Processing Method and Electronic Apparatus for Displaying Images Corresponding to Physical Objects”, discloses a processing method comprising: acquiring an instant image captured by a camera disposed on a physical object; acquiring one or more of the movement direction of the physical object, the speed of the physical object, and the acceleration of the physical object; and controlling the display device to display an instant image corresponding to the first event, in response to the first event triggered according to one or more of the moving direction of the physical object, the speed of the physical object and the acceleration of the physical object.

Taiwanese Patent No. I633500, “Augmented Reality Application Generation System and Method thereof”, discloses an Augmented Reality application generation system and method thereof. The method includes: capturing an image signal; identifying and tracking the image or mark of the image signal to obtain an image or mark position information; identifying and tracking a posture of the user in the image signal to obtain posture type information or posture position information; analyzing the image signal and the posture type information or the posture position information to generate corresponding human-machine interaction information; and according to the human-machine interaction information, providing at least one editing component to edit an interactive content of the Augmented Reality application, and then displaying the interactive content of the Augmented Reality application on a real image in a superposition manner.

Taiwanese Utility Model Publication No. M563613, “House Exhibition System that Provides Mixed Reality and Presents 3D Objects”, discloses a house exhibition system that provides a mixed reality and displays 3D objects, including: an information receiving/transmitting interface, a storage module, a 3D modeling module, and a processing module, in which the information receiving/transmitting interface is connected to a head-mounted mixed reality device, the house exhibition system can mix 3D housing objects stereo images with a mixed reality, under a real-world digital visual information environment provided by the head-mounted mixed reality device, and the user wearing the head-mounted mixed reality device can control the stereoscopic image of the 3D housing object in the mixed reality through a floating touch, and after touching the stereoscopic image of the 3D housing object, there will be an interactive window feedback to achieve an interaction of the house exhibition in an mixed reality environment.

Taiwanese Patent No. I628613, “Augmented Reality Methods and Systems”, discloses an Augmented Reality (AR) method including: photographing all physical objects in an entity space to obtain their respective depth information; generating their respective entity coordinates of the physical objects; constructing a 3D map of the entity space; identifying an AR configuration corresponding to the physical space; converting the respective AR virtual coordinates of the plurality of AR objects in the AR configuration to respective entity coordinates of the AR objects in the physical space; determining whether an AR placement error occurs; if an AR placement error occurs, adjusting a first AR virtual coordinate of the first AR object for at least one first AR object of the AR objects that causes the AR to be placed incorrectly; and performing an AR display.

Taiwanese Patent No. I618947, “Display Device”, discloses a display device, more particularly, a head mounted display or eyepiece, having a spatial light modulator (200) and an optical deflection device (400) for generating a segmented multiple imaging of the spatial light modulator, wherein the multiple imaging is performed in a manner having at least a predetermined number of multiple imaging segments, the number determining the size of the visual range within which the 3D scene encoded in the spatial light modulator observed by the observer's eye (1000) can be reconstructed.

Taiwanese Patent No. I590189, “Augmented Reality methods, systems, and computer readable non-transitory storage media”, discloses an Augmented Reality method comprising: selecting a virtual pattern associated with a real environment; configuring at least one virtual object's virtual placement in the virtual pattern; initializing and calibrating a coordinate system; and displaying an Augmented Reality in the calibrated coordinate system.

Thus, it is desired to solve the problem that the user only can browse the Augmented Reality visions with texts and/or pictures and/or multimedia files, but cannot perform some operations to the Augmented Reality visions with texts and/or pictures and/or multimedia files, such as adding text information and/or pictures, processing the background of the multimedia files (such as cards, creative works or image creations), taking an instant video recording interacting with the multimedia files (such as cards, creative works or image creations), and/or transmitting the processed multimedia files (such as cards, creative works or image creations) via an instant messaging software.

### SUMMARY OF THE INVENTION

A primary objective of the present invention is to provide an information service system and method thereof applied to an Augmented Reality information service environment. When implementing the information service method in the information service system of the present invention, first, the method comprises: performing a login step, scanning a QR Code with a lens of an electronic device and/or logging in a PIN number on a website to start a user interface; performing an Augmented Reality initiation step, after scanning a pattern and/or logging into the website, an Augmented Reality vision with a 3D animation appears, after a user clicks on the 3D animation, a multimedia file (such as cards, creative works or image creations) appears on the Augmented Reality vision with the 3D animation; and performing an information processing/transmission step, in the multimedia file (such as cards, creative works or image creations), in addition to the original image/text content, the user may add text information and/or pictures and/or personal photos and/or video recordings thereto, and/or may process a background of the multimedia file (such as cards, creative works or image creations) and/or take an instant video recording interacting with the multimedia file, and the processed multimedia file (such as cards, creative works or image creations) may be transmitted via an instant messaging software.

Another objective of the present invention is to provide an information service system and method thereof applied to an Augmented Reality information service environment. This method can solve the problem that the user only can browse the Augmented Reality vision with texts and/or pictures and/or multimedia files. This method can perform some operations to the Augmented Reality vision with texts and/or pictures and/or multimedia files, such as adding text information and/or pictures and/or personal photos and/or video recordings, processing the background of the multimedia file (such as cards, creative works or image creations), taking an instant video recording interacting with the multimedia files (such as cards, creative works or image creations), and/or transmitting the processed multimedia files (such as cards, creative works or image creations) via an instant messaging software.

According to the above objectives, the present invention provides an information service system, at least comprising an information service module and a database.

First, the information service module is described. The information service module cooperates with the database. After the user scans a QR Code with the lens of the electronic device and/or logs in the PIN number on the website, the information service module cooperates with the database to provide a user interface on a screen of the electronic device. That is, after scanning a pattern QR Code with the lens of the electronic device and/or logging into the website, the information service module cooperates with the database to provide a first frame of an Augmented Reality vision with a 3D animation on the screen of the electronic device, alter the user clicks on the 3D animation, a multimedia file (such as cards, creative works or image creations) appears on the Augmented Reality vision with the 3D animation; and the information service module cooperates with the database to provide a second frame on the screen of the electronic device, in the multimedia file of the second frame, in addition to the original image/text content therein, the user may add text information and/or pictures and/or personal photos and/or video recordings thereto, and/or the user may process a background of the multimedia file (such as cards, creative works or image creations) and/or take an instant video recording interacting with the multimedia file (such as cards, creative works or image creations), the processed multimedia file (such as cards, creative works or image creations) of the second frame by the information service module cooperated with the database, may be transmitted via an instant messaging software, such as e-mail, LINE, SMS, Facebook, IG, and YouTube, in the electronic device.

Next, the database is described. The database stores the data required for the operation of the information service module.

When implementing the information service method in the information service system of the present invention, first, the method comprises: performing a login step, scanning a QR Code with a lens of the electronic device and/or logging in a PIN number on a website to start a user interface. That is, after a user scans the QR Code with the lens of the electronic device and/or logs in the PIN number on the website, the information service module cooperates with the database to provide a user interface on a screen of the electronic device.

Next, performing an Augmented Reality initiation step, after scanning a pattern and/or logging into the website, an Augmented Reality vision with a 3D animation appears, after the user clicks on the 3D animation, a multimedia file (such as cards, creative works or image creations) appears on the Augmented Reality vision with the 3D animation. That is, after scanning a pattern with the lens of the electronic device and/or logging into the website, the information service module cooperates with the database to provide a first frame of an Augmented Reality vision with a 3D animation on the screen of the electronic device, after the user clicks on the 3D animation, a multimedia file (such as cards, creative works or image creations) appears on the Augmented Reality vision with the 3D animation.

Then, performing an information processing/transmission step, in the multimedia file (such as cards, creative works or image creations), in addition to the original image/text content, the user may add text information and/or pictures and/or personal photos and/or video recordings thereto, and/or the user may process the background of the multimedia file (such as cards, creative works or image creations) and/or take an instant video recording interacting with the multimedia file, the processed multimedia file (such as cards, creative works or image creations) may be transmitted via an instant messaging software in the electronic device; and the information service module cooperates with the database to provide a second frame on the screen of the electronic device, in the multimedia file (such as cards, creative works or it creations) of the second frame, in addition to the original image/text content, the user may add text information and/or pictures and/or personal photos and/or video recordings thereto, and/or the user may process the background of the multimedia file (such as cards, creative works or image creations) and/or take an instant video recording interacting with the multimedia file (such as cards, creative works or image creations), the processed multimedia file (such as cards, creative works or image creations) of the second frame by the information service module cooperated with the database, may be transmitted via an instant messaging software, such as e-mail, LINE, SMS, Facebook, IG, and YouTube, in the electronic device.

In order to enable those skilled in the art to understand the purpose, features and function of the invention, the invention is described in detail hereinafter by virtue of the following specific embodiments and the accompanying drawings.

### BRIEF DESCRIPTION OF THE DRAWINGS

FIG. 1 is a schematic system diagram showing the system architecture of the information service system of the present invention and operation thereof;

FIG. 2 is a flow diagram showing the steps of the information service method that is implemented in the information service system of the present invention as shown in FIG. 1;

FIG. 3 is a schematic diagram showing an embodiment of the information service system of the present invention and operation thereof;

FIG. 4 is a flow diagram showing the steps of the information service method that is implemented in an embodiment of the information service system of the present invention as shown in FIG. 3;

FIG. 5 is a schematic diagram showing another embodiment of the information service system of the present invention and operation thereof; and

FIG. 6 is a flow diagram showing the steps of the information service method that is implemented in another embodiment of the information service system of the present invention as shown in FIG. 5.

### DETAILED DESCRIPTION OF THE PREFERRED EMBODIMENT

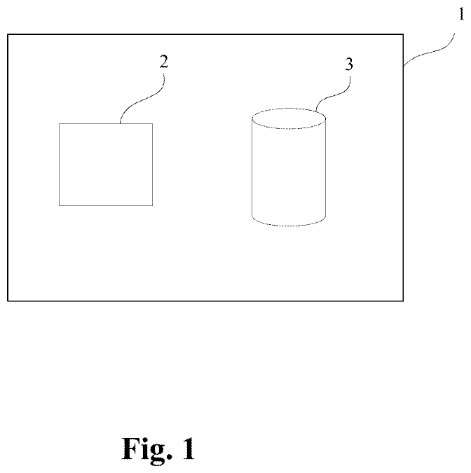

FIG. 1 is a system diagram showing the system architecture of the information service system of the present invention and operation thereof. As shown in FIG. 1, the information service system 1 at least includes an information service module 2 and a database 3.

Herein, the information service system 1 is located in an electronic device. The electronic device is one of iPhone, Android phone, tablet and iPad, and the information service module 2 can consist of at least one of a hardware, a software, and a firmware.

First, the information service module 2 is described. The information service module 2 cooperates with the database 3. After a user scans a QR Code with a lens of an electronic device and/or logs in a PIN number on a website, the information service module 2 cooperates with the database 3 to provide a user interface on a screen of the electronic device. For example, after scanning a pattern QR Code with the lens of the electronic device and/or logging into the website, the information service module 2 cooperates with the database 3 to provide a first frame of an Augmented Reality vision with a 3D animation on the screen of the electronic device; after the user clicks on the 3D animation, a multimedia file (such as cards, creative works or image creation) appears on the Augmented Reality vision with the 3D animation; and the information service module 2 cooperates with the database 3 to provide a second frame on the screen of the electronic device. In the multimedia file of the second frame, in addition to an original image/text content, the user may add text information and/or pictures and/or personal photos and/or video recordings thereto, and/or the user may process the background of the multimedia file (such as cards, creative works or image creations) and/or take an instant video recording interacting with the multimedia file (such as cards, creative works or image creations). The processed multimedia file (such as cards, creative works or image creations) of the second frame by the information service module 2 cooperated with the database 3, may be transmitted via an instant messaging software, such as e-mail, LINE, SMS, Facebook, IG, and YouTube.

Next, the database 3 is described. The database 3 stores the data required for the operation of the information service module 2, including, for example, the information of the user interface, the information of the first frame of the Augmented Reality vision with the 3D animation, and the information of the multimedia file (such as cards, creative works or image creations) appeared on the Augmented Reality vision with the 3D animation, the information of the second frame, the text information and/or pictures and/or personal photos and/or video recordings that may be added into the second frame by the user, in addition to the information of the original image/text content therein, and/or the information of processing the background of the multimedia file (such as cards, creative works or image creations) and/or the information of taking an instant video recording interacting with the multimedia file (such as cards, creative works or image creations).

In implementing the present invention, the multimedia file may be, for example, cards, creative works or image creations, but the multimedia file in the present invention is not limited to the form of card, but may be any form of multimedia. The first frame and the second frame may be displayed on the screen of the electronic device as the respective frame, or both of them may be displayed on the screen of the electronic device as the same frame, depending on actual implementation.

The information service module 2 is composed of at least one of an electronic hardware, a firmware, and a software. The information service module 2 cooperates with a processor (not shown) of an electronic device, such as iPhone, Android mobile phone, tablet or iPad, on which the information service system 1 is installed, to perform some operations. The database 3 is located in a storage module (not shown) of the iPhone, Android mobile phone, tablet, and iPad. The storage module may be one of a mobile phone memory module, an iPhone memory module, a tablet memory module, and an iPad memory module.

In addition, in actual implementation, when the electronic device operated by the user is one of smart phone, iPhone, tablet and iPad, the information service system is located in one of the smart phone, iPhone, tablet and iPad, and thus the first frame and the second frame may be one of a smart phone App interface, an iPhone App interface, a tablet App interface, and an iPad App interface.

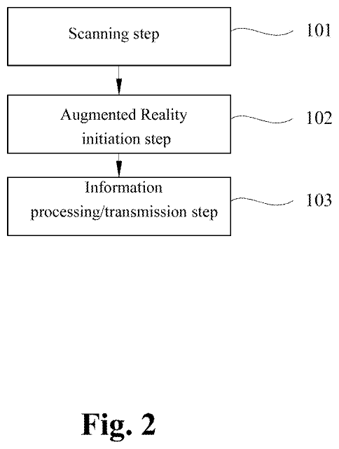

FIG. 2 is a flow diagram showing the steps of the information service method that is implemented in the information service system of the present invention as shown in FIG. 1. As shown in FIG. 2, first, in the step 101, performing a login step, scanning a QR Code with a lens of an electronic device and/or logging in a PIN number on a website to start a user interface. That is, after the user scans the QR Code with the lens of the electronic device and/or logs in the website, the information service module 2 cooperates with the database 3 to provide a user interface a screen of the electronic device. Then, enter into the step 102.

In the step 102, performing an Augmented Reality initiation step, after scanning a pattern and/or logging into the website, an Augmented Reality vision with a 3D animation appears; after the user clicks on the 3D animation, a multimedia file (such as cards, creative works or image creations) appears on the Augmented Reality vision with the 3D animation. That is, after scanning a pattern with the lens of the electronic device and/or logging into the website, the information service module 2 cooperates with the database 3 to provide a first frame of an Augmented Reality vision with a 3D animation on the screen of the electronic device; after the user clicks on the 3D animation, a multimedia file (such as cards, creative works or image creations) appears on the Augmented Reality vision with the 3D animation. Then, enter into the step 103.

In the step 103, performing an information processing/transmission step, in the multimedia file (such as cards, creative works or image creations), in addition to the original image/text content, the user may add text information and/or pictures and/or personal photos and/or video recordings thereto, and/or may process the background of the multimedia file (such as cards, creative works or image creations) and/or take an instant video recording interacting with the multimedia file, and the processed multimedia file (such as cards, creative works or image creations) may be transmitted via an instant messaging software. That is, the information service module 2 cooperates with the database 3 to provide a second frame on the screen of the electronic device, in the multimedia file (such as cards, creative works or image creations) of the second frame, in addition to the original image/text content, the user may add text information and/or pictures and/or personal photos and/or video recordings, and/or may process the background of the multimedia file (such as cards, creative works or image creations) and/or take an instant video recording interacting with the multimedia file (such as cards, creative works or image creations), the processed multimedia file (such as cards, creative works or image creations) of the second frame by the information service module 2 cooperated with the database 3, may be transmitted via an instant messaging software, such as e-mail, LINE, SMS, Facebook, IG, and YouTube.

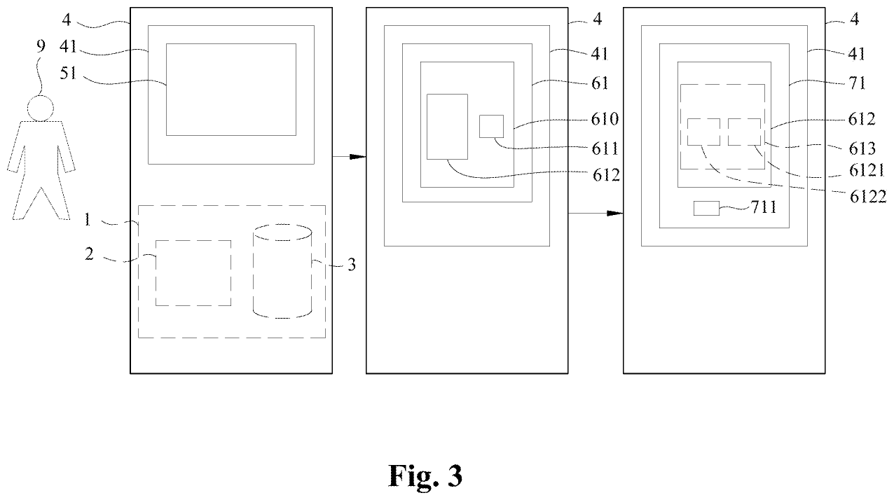

FIG. 3 is a schematic diagram showing an embodiment of the information service system of the present invention and operation thereof. As shown in FIG. 3, the information service system 1 at least includes an information service module 2 and a database 3.

Herein, the information service system 1 is located in a phone 4, and the information service module 2 can consist of at least one of a hardware, a software, and a firmware.

First, the information service module 2 is described. The information service module 2 cooperates with the database 3. After a user 9 scans a QR Code with a lens of the phone 4, the information service module 2 cooperates with the database 3 to provide a user interface 51 on a screen 41 of the phone 4. After scanning a pattern by the phone 4, the information service module 2 cooperates with the database 3 to provide a first frame 61 of an Augmented Reality vision 610 with a 3D animation 611 on the screen 41 of the phone 4; after the user 9 clicks on the 3D animation 611, a card 612 appears on the Augmented Reality vision 610 with the 3D animation 611, the information service module 2 cooperates with the database 3 to provide a second frame 71 to the screen 41 of the phone 4. In the card 612 of the second frame 71, in addition to the original image/text content, the user 9 may add text information 6121 to a text box and/or add an instant photo or a picture selected from a picture library and/or personal photo and/or video recording information 6122 thereto; and/or the user 9 may process a background 613 of the card 612, and may add an instant photo or a picture selected from a picture library thereto; and/or the user 9 may click on a lower camera icon 711 of the second frame 71, the entire second frame 71 and the background 613 may be immediately photographed and thus transmitted via an instant messaging software, such as e-mail, LINE, SMS, Facebook, IG, and YouTube, in the phone 4.

Next, the database 3 is described. The database 3 stores the data required for the operation of the information service module 2, including, for example, the information of the user interface 51, the information of the first frame 61 of the Augmented Reality vision 610 with the 3D animation 611, the information of the card 612 appeared on the Augmented Reality vision 610 with the 3D animation 611, the information of the second frame 71, the text information 6121 and/or an instant photo or a picture selected from a picture library and/or personal photo and/or video recording information 6122 that may be added into the card 612 of the second frame 71 by the user, in addition to the information of the original image/text content therein, and/or the information of processing the background 613 of the card.

In this embodiment, after scanning the QR Code, the information service module 2 cooperates with the database 3 to provide a user interface on the screen of the electronic device of the phone 4. Similarly, in the case of logging in the PIN number on the website, the principle is similar to that described in the embodiment, and thus the details are not described herein. Moreover, the multimedia file is, for example, a card. The multimedia file in the present invention is not limited to the type of a card, but may be any other types, such as creative works or image creations. The principle is similar to that described in the embodiment, and thus the details are not described herein. In addition, in actually implementing this embodiment, the first frame 61 and the second frame 71 may be displayed on the screen 41 of the phone 4 as the respective frame, or both of them can be displayed on the screen 41 of the phone 4 as the same frame, depending on actual implementation.

Further, according to the implementation requirements, the information service system 1 may be located in the phone 4 of an iPhone or an Android mobile phone, or the information service system 1 also may be located in one of tablet and iPad.

The information service module 2 is composed of at least one of an electronic hardware, a firmware, and a software, and cooperates with a processor (not shown) of the phone 4, or a tablet or iPad, on which the information service system 1 is installed, to perform some operations. The database 3 is located in a storage module (not shown) of Android mobile phone, iPhone, tablet, and iPad. The storage module can be one of a mobile phone memory module, an iPhone memory module, a tablet memory module, and an iPad memory module.

In addition, in actual implementation, when the electronic device operated by the user 9 is one of Android mobile phone, iPhone, tablet and iPad, the information service system 1 is located on the Android mobile phone, iPhone, tablet and iPad, and thus the first frame 61 and the second frame 71 can be one of a smart phone App interface, an iPhone App interface, a tablet App interface, and an iPad App interface.

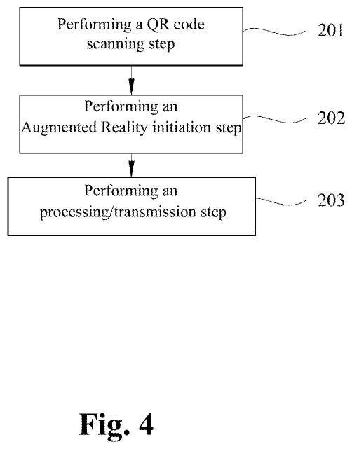

FIG. 4 is a flow diagram showing the steps of the information service method that is implemented in an embodiment of the information service system of the present invention as shown in FIG. 3. As shown in FIG. 4, first, in the step 201, performing a login step, scanning a QR Code with a lens of the phone 4 to start a user interface. This is, after the user 9 scans the QR Code with the lens of the phone 4, the information service module 2 cooperates with the database 3 to provide a user interface 51 on the screen 41 of the phone 4. Then, enter into the step 202.

In the step 202, performing an Augmented Reality initiation step, after scanning the pattern, the Augmented Reality vision 610 with the 3D animation 611 appears; after the user 9 clicks on the 3D animation 611, the card 612 appears on the Augmented Reality vision 610 with the 3D animation 611. After scanning the pattern by the phone 4, the information service module 2 cooperates with the database 3 to provide the first frame 61 of the Augmented Reality vision 610 with the 3D animation 611 on the screen 41 of the phone 4; after the user 9 clicks on the 3D animation 611, the card 612 appears on the Augmented Reality vision 610 with the 3D animation 611. Then, enter to the step 203.

In the step 203, performing an information processing/transmission step, the information service module 2 cooperates with the database 3 to provide the second frame 71 to the screen 41 of the phone 4. In the card 612 of the second frame 71, in addition to the original image/text content, the user 9 may add text information 6121 to a text box and/or add an instant photo or a picture selected from a picture library and/or personal photo and/or video recording information 6122 thereto, and/or the user 9 may process the background 613 of the card 612, and may add an instant photo or a picture selected from the picture library thereto; and/or the user 9 can click on the lower camera icon 711 of the second frame 71, the entire second frame 71 and the background 613 can be immediately photographed and thus transmitted via an instant messaging software, such as e-mail, LINE, SMS, Facebook, IG, and YouTube, in the phone 4.

In this embodiment, after scanning the QR Code, the information service module 2 cooperates with the database 3 to provide a user interface on the screen of the electronic device of the phone 4. Similarly, in the case of logging in the PIN number on the website, the principle is similar to that described in the embodiment, and thus the details are not described herein. Moreover, the multimedia file is, for example, a card. The multimedia file in the present invention is not limited to the type of a card, but may be any other types, such as creative works or image creations. The principle is similar to that described in the embodiment, and thus the details are not described herein. In addition, in actually implementing this embodiment, the first frame 61 and the second frame 71 may be displayed on the screen 41 of the phone 4 as the respective frame, or both of them can be displayed on the screen 41 of the phone 4 as the same frame, depending on actual implementation.

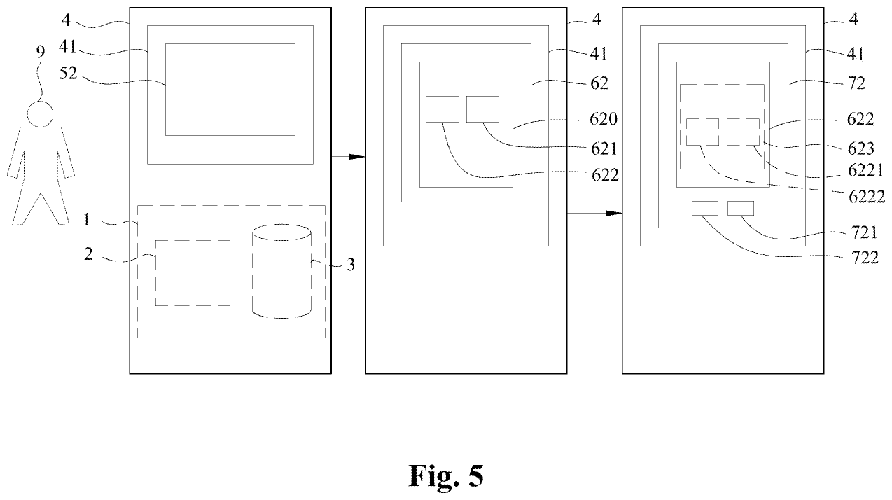

FIG. 5 is a schematic diagram showing another embodiment of the information service system of the present invention and operation thereof. As shown in FIG. 5, the information service system 1 at least includes an information service module 2 and a database 3. Herein, the information service system 1 is located in the phone 4, and the information service module 2 can consist of at least one of a hardware, a software and a firmware.

First, the information service module 2 is described. The information service module 2 cooperates with the database 3. After the user 9 scans the QR Code with the lens of the phone 4, the information service module 2 cooperates with the database 3 to provide a user interface 52 on the screen 41 of the phone 4. After scanning a pattern by the phone 4, the information service module 2 cooperates with the database 3 to provide a first frame 62 of an Augmented Reality vision 620 with a 3D animation 621 on the screen 41 of the phone 4; after the user 9 clicks on the 3D animation 621, a card 622 appears on the Augmented Reality vision 620 with the 3D animation 621, the information service module 2 cooperates with the database 3 to provide a second frame 72 to the screen 41 of the phone 4. In the card 622 of the second frame 72, in addition to the original image/text content, the user 9 may add text information 6221 to a text box and/or add an instant photo or a picture selected from a picture library and/or personal photo and/or video recording information 6222 thereto; and/or the user 9 may process a background 623 of the card 622, and may add an instant photo or a picture selected from a picture library thereto; and/or the user 9 can click on a lower camera icon 721 of the second frame 72, so that the entire second frame 72 and the background 623 can be immediately photographed; and/or the user 9 can click on a lower video recording icon 722 of the second frame 72, so as to take an instant video recording interacting with the card 622, and the processed card 622 of the second frame 72 by the information service module 2 cooperated with the database 3, may be transmitted via an instant messaging software, such as e-mail, LINE, SMS, Facebook, IG, and YouTube, in the phone 4.

Next, the database 3 is described. The database 3 stores the data required for the operation of the information service module 2, including, for example, the information of the user interface 52, the information of the first frame 62 of the Augmented Reality vision 620 with the 3D animation 621, the information of the card 622 appeared on the Augmented Reality vision 620 with the 3D animation 621, the information of the second frame 72, the text information 6221 and/or an instant photo or a picture selected from a picture library and/or personal photo and/or video recording information 6222 that may be added into the card 622 of the second frame 72 by the user, in addition to the information of the original image/text content therein, and/or the information of processing the background 623 of the card 622 and/or performing an instant video recording interacting with the card 622.

In this embodiment, after scanning the QR Code, the information service module 2 cooperates with the database 3 to provide a user interface on the screen of the electronic device of the phone 4. Similarly, in the case of logging in the PIN number on the website, the principle is similar to that described in the embodiment, and thus the details are not described herein. Moreover, the multimedia file is, for example, a card. The multimedia file in the present invention is not limited to the type of a card, but may be any other types, such as creative works or image creations. The principle is similar to that described in the embodiment, and thus the details are not described herein. In addition, in actually implementing this embodiment, the first frame 61 and the second frame 71 may be displayed on the screen 41 of the phone 4 as the respective frame, or both of them can be displayed on the screen 41 of the phone 4 as the same frame, depending on actual implementation.

Further, according to the implementation requirements, the information service system 1 may be located in the phone 4 of an iPhone or an Android mobile phone, or the information service system 1 also may be located in one of tablet and iPad.

The information service module 2 is composed of at least one of an electronic hardware, a firmware, and a software, and cooperates with a processor (not shown) of the phone 4, or a tablet or iPad, on which the information service system 1 is installed, to perform some operations. The database 3 is located in a storage module (not shown) of Android mobile phone, iPhone, tablet, and iPad. The storage module can be one of a mobile phone memory module, an iPhone memory module, a tablet memory module, and an iPad memory module.

In addition, in actual implementation, when the electronic device operated by the user 9 is one of Android mobile phone, iPhone, tablet and iPad, the information service system 1 is located on the smart phone, iPhone, tablet and iPad, and thus the first frame 61 and the second frame 71 can be one of a smart phone App interface, an iPhone App interface, a tablet App interface, and an iPad App interface.

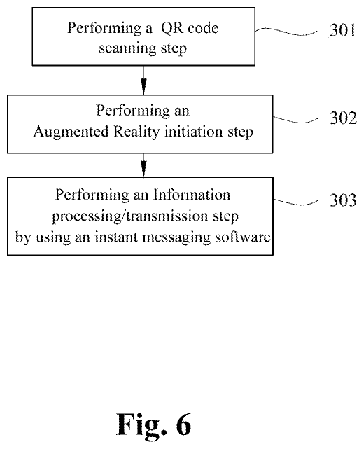

FIG. 6 is a flow diagram showing the steps of the information service method that is implemented in another embodiment of the information service system of the present invention as shown in FIG. 5. As shown in FIG. 6, first, in the step 301, performing a login step, scanning the QR Code with the lens of phone 4 to start a user interface. That is, after the user 9 scans the QR Code with the lens of the phone 4, the information service module 2 cooperates with the database 3 to provide a user interface 52 on the screen 41 of the phone 4. Then, enter into the step 302.

In the step 302, performing an Augmented Reality initiation step, after scanning the pattern, the Augmented Reality vision 620 with the 3D animation 621 appears; after the user clicks on the 3D animation 621, the card 622 appears on the Augmented Reality vision 620 with the 3D animation 621. After scanning the pattern by the phone 4, the information service module 2 cooperates with the database 3 to provide the first frame 62 of the Augmented Reality vision 620 with the 3D animation 621 on the screen 41 of the phone 4; after the user 9 clicks on the 3D animation 621, the card 622 appears on the Augmented Reality vision 620 with the 3D animation 621. Then, enter into the step 303.

In the step 303, performing an information processing/transmission step, the information service module 2 cooperates with the database 3 to provide the second frame 72 to the screen 41 of the phone 4. In the card 622 of the second frame 72, in addition to the original image/text content, the user 9 may add text information 6221 to a text box and/or add an instant photo or a picture selected from a picture library and/or personal photo and/or video recording information 6222 thereto, and/or the user 9 may process the background 623 of the card 622, and may add an instant photo or a picture selected from the picture library thereto; and/or the user can click on the lower camera icon 721 of the second frame 72, the entire second frame 72 and the background 623 may be immediately photographed; and/or the user 9 can click on the lower video recording icon 722 of the second frame 72, so as to take an instant video recording interacting with the card 622, and the processed card 622 of the second frame 72 by the information service module 2 cooperated with the database 3, may be transmitted via an instant messaging software, such as e-mail, LINE, SMS, Facebook, IG, and YouTube, in the phone 4.

In combination with the above embodiments, the present invention provides an information service system and method thereof applied to an Augmented Reality information service environment. When implementing the information service method in the information service system of the present invention, first, the method comprises: performing a login step, scanning a QR Code with a lens of the electronic device and/or logging in a PIN number on a website to start a user interface; then performing an Augmented Reality initiation step, after scanning a pattern and/or logging into the website, an Augmented Reality vision with a 3D animation appears, after the user clicks on the 3D animation, a multimedia file (such as cards, creative works or image creations) appears on the Augmented Reality vision with the 3D animation; and then performing an information processing/transmission step, in the multimedia file (such as cards, creative works or image creations), in addition to the original image/text content, the user may add text information and/or pictures and/or personal photos and/or video recordings thereto, and/or may process the background of the multimedia file (such as cards, creative works or image creations) and/or take an instant video recording interacting with the multimedia file, and the processed multimedia file (such as cards, creative works or image creations) may be transmitted via an instant messaging software. The information service system and method thereof of the present invention include the following advantages:

1. Providing an information service system and method thereof applied to an Augmented Reality information service environment. When implementing the information service method in the information service system of the present invention, first, performing a login step, scanning the QR Code with the lens of the electronic device and/or logging in the PIN number on the website to start the user interface; then performing an Augmented Reality initiation step, after scanning a pattern and/or logging into the website, an Augmented Reality vision with a 3D animation appears, after the user clicks on the 3D animation, a multimedia file appears (such as cards, creative works or image creations) appears on the Augmented Reality vision with the 3D animation; and then performing an information processing/transmission step, in the multimedia file (such as cards, creative works or image creations), in addition to the original image/text content, the user may add text information and/or pictures and/or personal photos and/or video recordings thereto, and/or may process the background of the multimedia file (such as cards, creative works or image creations), and/or take an instant video recording interacting with the multimedia file, and the processed multimedia file (such as cards, creative works or image creations) may be transmitted via an instant messaging software.

2. This method can solve the problem that the user only can browse the Augmented Reality vision with texts and/or pictures and/or multimedia files. This method can perform some operations to the Augmented Reality visions with texts and/or pictures and/or multimedia files, such as adding text information and/or pictures and/or personal photos and/or video recordings, processing the background of the multimedia file (such as cards, creative works or image creations), taking an instant video recordings interacting with the multimedia file (such as cards, creative works or image creations), and/or transmitting the processed multimedia file (such as cards, creative works or image creations) via an instant messaging software.

The above are only the preferred embodiments of the present invention, and are not intended to limit the scope of the present invention Any other equivalent changes or modifications which are not departing from the spirit of the present invention, should all be included in the scope of the present application.

What is claimed is:

1. An information service method applied to an Augmented Reality information service environment, comprising the following steps:
performing a login step, wherein scanning a QR Code with a lens of an electronic device and/or logging in a PIN number on a website to start a user interface and after a user scans the QR Code with the lens of the electronic device and/or logs in the PIN number on the website, the user interface is provided on a screen of the electronic device;
performing an Augmented Reality initiation step, wherein after scanning a pattern and/or logging into the website, an Augmented Reality vision with a 3D animation appears, after the user clicks on the 3D animation, a multimedia file appears on the Augmented Reality vision with the 3D animation; and
performing an information processing/transmission step, wherein the multimedia file is added with information in addition to an original image/text content, and the processed multimedia file is then transmitted via an instant messaging software in the electronic device,
wherein the electronic device is one of iPhone, Android phone, tablet and iPad.

2. The information service method according to claim 1, wherein the information added is text information and/or pictures and/or personal photos and/or video recordings.

3. The information service method according to claim 1, wherein the adding the information is to perform the processing of a background for the multimedia file.

4. The information service method according to claim 1, further comprising performing an instant video recording interacting with the multimedia profile.

5. The information service method according to claim 1, wherein the instant messaging software is at least one of e-mail, LINE, SMS, Facebook, IG, and YouTube.

6. An information service system applied to an Augmented Reality information service environment, comprising:
a database; and
an information service module, wherein scanning a QR Code with a lens of an electronic device and/or logging in a PIN number on a website to start a user interface; after a user scans the QR Code with the lens of the electronic device and/or logs in the PIN number on the website, the information service module cooperates with the database to provide the user interface on a screen of the electronic device; after scanning a patient and/or logging into the website, the information service module cooperates with the database, an Augmented Reality vision with a 3D animation appears on the screen of the electronic device, and after the user clicks on the 3D animation, a multimedia file appears on the Augmented Reality vision with the 3D animation; and the information service module cooperates with the database to add information in the multimedia file in addition to an original image/text content, and the processed multimedia file is transmitted via an instant messaging software in the electronic device,
wherein the electronic device is one of iPhone, Android phone, tablet and iPad.

7. The information service system according to claim 6, wherein the information added is text information and/or pictures and/or personal photos and/or video recordings.

8. The information service system according to claim 6, wherein the adding the information is to perform the processing of a background for the multimedia file.

9. The information service system according to claim 6, wherein an instant video recording interacts with the multimedia profile.

10. The information service system according to claim 6, wherein the instant messaging software is at least one of e-mail, LINE, SMS, Facebook, IG, and YouTube.
